(19) United States
(12) Patent Application Publication
(10) Pub. No.: US 2008/0103989 A1
(43) Pub. Date: May 1, 2008

(54) SYSTEM AND METHOD FOR CONFIGURABLY DISPLAYING MARKET INFORMATION FOR AN ASSET

(75) Inventor: ROBERTO LLOPES LEE, SAO PAOLO (BR)

Correspondence Address: COLLARD & ROE, P.C., 1077 NORTHERN BOULEVARD, ROSLYN, NY, 11576, US

(73) Assignee: ALPES CORRECTORA DE CAMBIO TITULOS E VALORES MOBILARIOS LTDA, SAO PAOLO (BR)

(21) Appl. No.: 11/923,759

(22) Filed: Oct. 25, 2007

Related U.S. Application Data
(60) Provisional application No. 60/854,717, filed on Oct. 27, 2006.

(51) Int. Cl. G06Q 40/00; G06F 19/00

(52) U.S. Cl. 705/36 R

(57) ABSTRACT

Systems and methods are furnished to efficiently display market information about an asset. The information displayed about an asset commercialized in a market includes a window, including a market information display area, an offer button, a graphic button, a details button in the window and a configuration button in the window. The information shown in the display area varies when the configuration button is selected and one of the buttons, whether offers, graphics or details are also selected.

### CROSS REFERENCES TO RELATED APPLICATIONS

This application claims priority for the U.S. Provisional Application No. 60/854,717, filed on Oct. 27, 2006, which is hereby incorporated into this document as a reference, up to the point allowed by law.

### FIELD OF THE INVENTION

The present invention generally refers to the display of market information about an asset, and particularly to configuration options for the display of that information.

### BACKGROUND

Traditionally, stock markets were restricted to large institutional investors, funds, countries, banks and large companies. Since the early 1990s, the Internet increased the number of home brokers and small investors. These investors had access to newspapers, magazines and other periodicals that could help them to make appropriate investments.

However, even with all of the information mentioned above, private and small investors perhaps had no access to sufficient complete and precise information to make safe investments. In addition, perhaps the user did not know how to work with complex analytical information. Software applications that provided stock market information for users normally show only gross and disorganized information. The applications may simultaneously show hundreds of different types of data.

Therefore, there is a need in the art for an application that provides stock market data in a meaningful, simple, and customizable way.

### SUMMARY

Systems and methods are presented for an efficient display of market information about an asset. The systems and methods consistent with the present invention aim to show information about an asset traded on a market. The method includes displaying a window with an area showing market information. The display window also includes a button for offers, a graphics button, a button for details and a configuration button. The information is showed in the display area is varied when the configuration button is selected based on which of the other buttons—offers button, graphics button and details button—is also selected. The varied information includes configuration options for the window.

Below we shall see some illustrative examples consistent with the present invention. When the offers button is selected, the selection of the configuration button provides options for at least one of the sales offers for an asset at the same price, classifying purchase offers for an asset at the same price, showing all of the sales offers for an asset and changing the color of the display window. When the graphics button is selected, the selection of the configuration button furnishes options to show market information in graphs. These options may include showing market information for an asset based on one of the daily, weekly, monthly, annually, quarterly periods and a user-defined period. When the details button is selected, the selection of the configuration button provides options to show at least the maximum price information, minimum price information, profit information, loss information and earnings per share information.

In one embodiment consistent with the present invention, the method also includes showing a “more” button and the variation of information shown in the display area when the configuration button is selected and the “more” button is also selected. The information may include at least one of the purchase option information items, historical information about the asset and news information about the asset. The stock purchase option information includes the purchase and sale option information. The new information about the asset includes news about the company related to the asset.

The methods described above may be implemented as instructions readable on a computer and stored in a medium readable by a computer.

Other systems, methods, characteristics and advantages consistent with the present invention become apparent to a person skilled in the art upon examining the following figures and detailed description. The intention is for these systems, methods, characteristics and additional advantages to be included within this description and within the scope of the invention.

### BRIEF DESCRIPTION OF THE DRAWINGS

The attached drawings that are incorporated and are an integral part of this specification illustrate an implementation of methods and systems consistent with the present invention and, together with the description help to explain the advantages and principles consistent with the invention. In the drawings:

FIG. 1 shows a panorama of the system consistent with the present invention;

FIG. 2 shows a computer model system;

FIG. 3 shows a market data display panel consistent with the present invention;

FIG. 4 shows a top area consistent with the present invention;

FIG. 5 shows the offer configuration options consistent with the present invention;

FIG. 6 shows the graphics configuration options consistent with the present invention;

FIG. 7 shows the details configuration options consistent with the present invention;

FIG. 8 shows the “more” configuration options consistent with the present invention;

FIG. 9 described a flowchart illustrating a method to display market information for an asset consistent with the present invention.

### DETAILED DESCRIPTION

Here we make a detailed reference to an implementation consistent with the present invention as illustrated in the attached drawings.

As described in the attached figures, the methods and systems consistent with the present invention provides a market data display of an asset and facilitate the easy understanding of market information. Market information about an asset may include, for example, the performance history, the company's ticker symbol, offer price, sales price, offer size, sales size, last sale, last size, quotation time, foreign exchange rate, volume and other facts that become apparent by the following description and how they are understood by one of ordinary skill in the art. The methods and systems consistent with the present invention increase the probability that a user will understand market information, providing a personalized interface to display market data.

One embodiment consistent with the present invention is implemented in a computer or electronic terminal. The computer is able to communicate both directly or indirectly (using intermediate devices) with a stock market to receive and transmit, for example, market information, commodities and trading order information. The computer is able to interact with the user and to generate and display market information in a customizable interface. The methods and system consistent with the present invention may be implemented in any existing or future terminal or a device with the processing capability to carry out the functions described in this document.

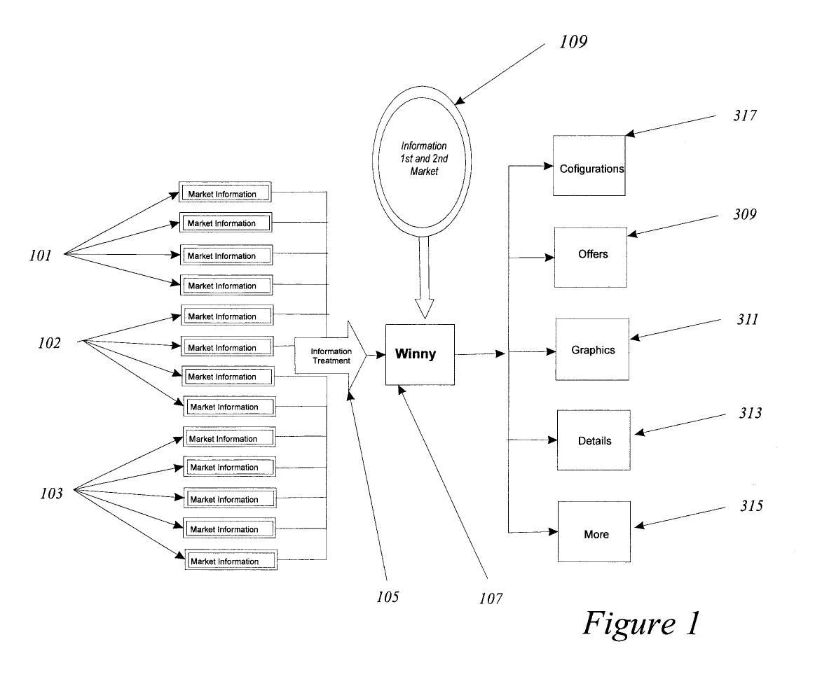

A system consistent with the present invention may be configured to display information from multiple stock markets, as illustrated in FIG. 1. This figure shows multiply host stock markets 101-103 connected to a market data server 105. The market data server 105 aggregates information from stock markets 101-103 to display in at least one client terminal 107 to use to display market information for the user. The client's terminal 107 is connected to the market data server, directly or indirectly, such as a network 109 with information in the first and second markets. In addition, the information shown in the Central Area of Winny may be selected, according to your needs. The client terminal 107 includes instructions executable by computer to display a market data display interface (described below). When the system is configured to receive data from different stock markets, then a preferred implementation is to translate the data from different stock markets into a simple format. Thus, while a reference is made during the rest of this specification to a single stock market connected to a negotiation terminal, the scope of the invention includes the capacity to negotiate, according to the commercial methods illustrated and described in this document, in multiple stock markets using a single negotiation terminal.

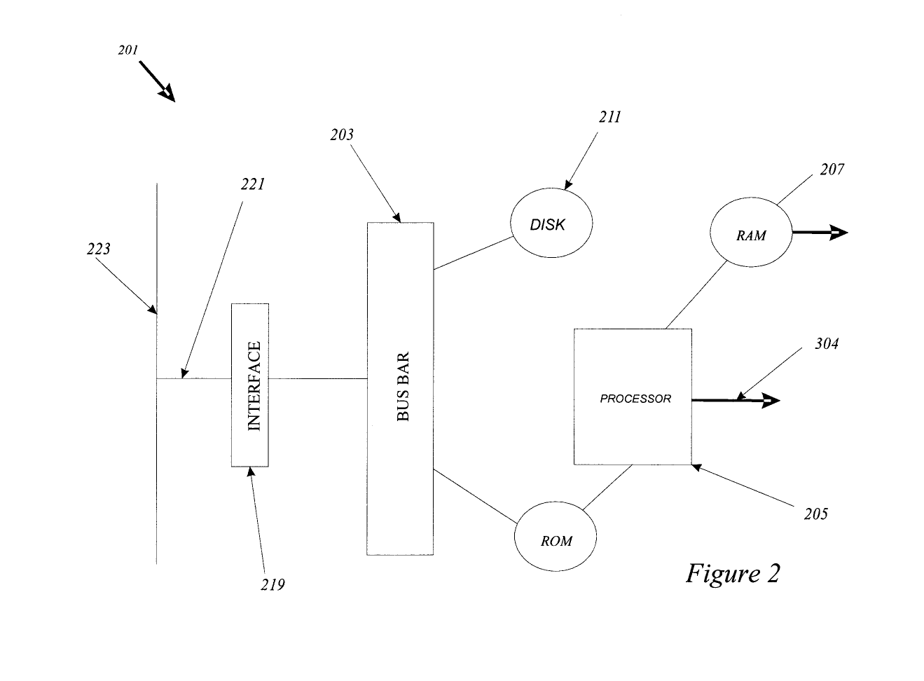

Returning to FIG. 2, we now describe a model computer system that may be configured as a market data server consistent with the present invention. The System 201 includes a bus bar 203 or another communication mechanism to communicate information, and a processor 205 coupled to a bus bar 203 for processing the information. The system 201 also includes a main memory 207, such as a random access memory (RAM) or another dynamic storage device coupled to a bus bar 203 to store information and instructions to be executed by the processor 205. In addition, the main memory 207 may be used to store temporary variables or other intermediate information during the execution of the instruction and to be executed by the processor 205. The main memory 207 may be configured to store instruction executable by the computer from a display program 233 to display the market data display program 301 (describe below). The system 201 also includes a read only memory (ROM) 209 or another static storage device coupled to the bus bar 203 to store static information and instructions for the processor 205. A storage device 211, such as a magnetic disk or an optical disk is provided and coupled to a bus bar 203 to store information and instructions.

According to one embodiment, the processor 205 executes one or more sequences of one or more instructions contained in the main memory 207. These instructions may be read into main memory 207 from another computer-readable medium, such as a storage device 211. The execution of instructions sequences in the main memory 207 causes the processor 205 to execute the process steps described herein. One or more processors in a combination of multi-processors arrangement may also be used to execute the instructions sequences contained in the main memory 207. In alternative embodiments, hard-wired circuitry may be used instead or in combination with software instructions. Therefore, the embodiments are not limited to a specific hardware or software circuitry combination.

Furthermore, the instructions to support the system's interface and the system's protocols 201 may reside in a medium readable by a computer. The term “medium readable by computer” as used in the document refers to any medium that furnishes instructions to the processor 205 for execution. Common media readable by computer include a floppy disk, flexible disk, hard disk, magnetic tape, CD-Rom, optical or physical medium, RAM, PROM and EPROM, a FLASH-EPROM and any other memory or cartridge chip, or any other medium from which the computer may read and that already now or later discovered.

The system 201 also includes a communication interface 219 coupled to a bus bar 203. The communication interface 219 provides a two-way data communication connection for a network connection 221 that is connected to a local network 223. The wireless connections may also be implemented. In any of these implementations, communication interface 219 forwards and receives signals that contain digital data current that present diverse types of information.

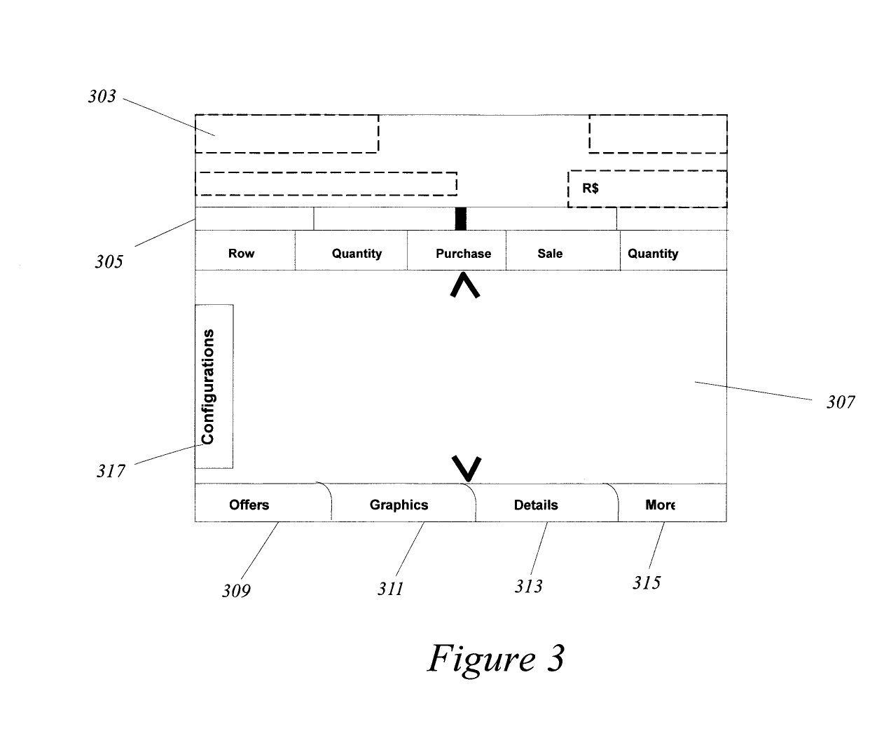

FIG. 3 shows a market data display interface 301 for the display program 233 consistent with the present invention. The market data display interface 301 includes a top area (303 to display current date about the asset. The top area 303 is explained in detail below. The market data display interface 301 also includes a price bar 305 to view prices as a function of horizontal distance. The price bar 305 may indicate the price with the first part of the horizontal bar having a color or shade different from the second part. Alternatively, the price may be indicated in a horizontal bar by a marker (not shown). The market display interface 301 also includes a display area 307 to show market information. The market display interface 301 also includes an offer button 309, a graph button 311, a detail button 313, a “more” button 315 and a configuration button 317. Each of these buttons is an illustrative example consistent with the present invention and shall be described in more detail below. The configuration button 317 is a multifunctional button whose function will change depending on which of the buttons is selected such as the offer button 309, graphs 311, details 313 or “more” 315.

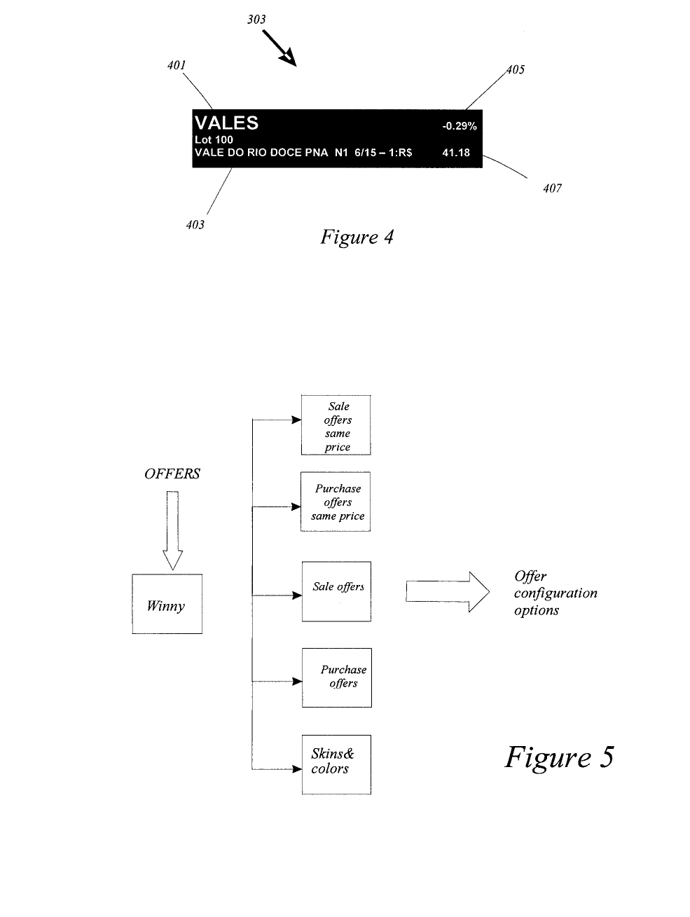

FIG. 4 illustrates in more detail the top area 303 of the market display interface 301. The top area 303 includes an asset code area 401, an asset description area 403, a percentage change area 405 and a price display area 407. The assets symbol area 401 displays an asset's negotiation symbol, for example, the negotiation symbol (ticker symbol). A user may select an asset by typing in its negotiation symbol or name. In a embodiment consistent with the present invention, the user selects all of the assets available in the national and international markets, for example, shares, options, public and private notes, derivatives and other asset varieties. The asset description area 403 furnished a description of the asset selected. The asset description area 403 may show the complete name of the asset, the date and time of the last negotiation, the quantity of the last negotiation. The percentage change area 405 provides a display of the percentage of change in the asset price for a quotation period. In a embodiment consistent with the present invention, the quotation period is measure from the closing on the business day prior to the present date. The second level of the percentage change area 405 may show the change in the asset's value. For example, when the value of the asset increases, the second level may become green, and when the asset value falls, the second level may become red. A person familiar with the art will understand that other color or shade variations or other types of indicators may be used. The price display area 407 show the asset's most recent price. The values may be displayed in currency values or index points.

FIG. 5 shows the illustrative configuration options available when the offer button 309 is selected. When this button is selected the display area 307 shows the asset's purchase and/or sales offers as classified from the most recent to the oldest. By selecting the configuration button 317, the user is shown the options to classify the sales offers with the same price 501, to choose the purchase offers with the same price 503, to view only the sales offers 505, to view only the purchase offers 507, and to change the display interface colors/skins for the market data display 301. The terms “purchase offers” and “sales offers” are known by people familiar with the subject. In each of these visualizations, the display may be limited to the 10 most recent instances.

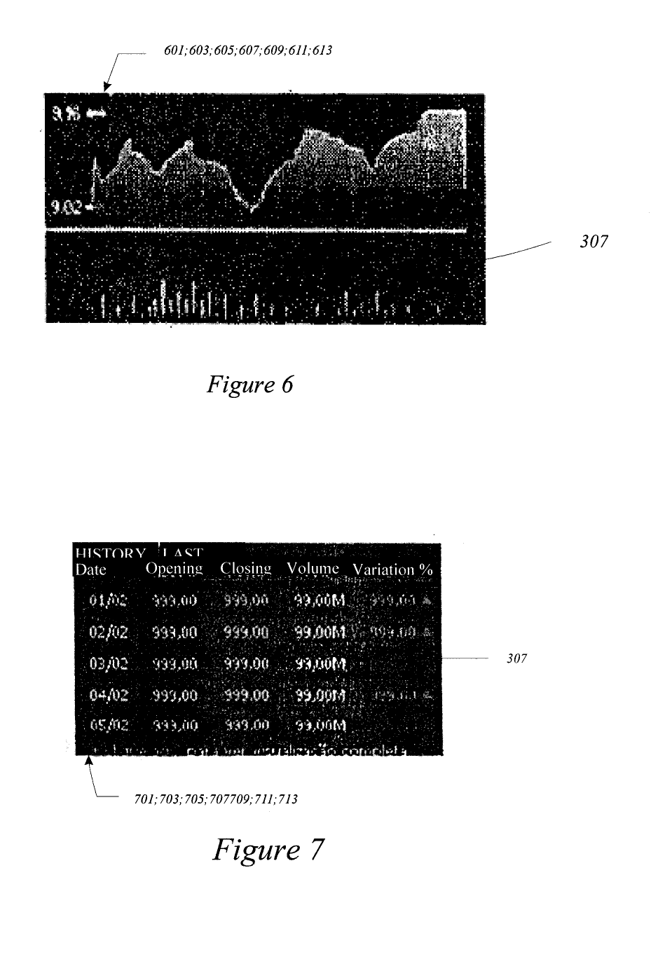

FIG. 6 illustrates the configuration options available when the graph button 311 is selected. By selecting this button the display area 307 will show the asset's market performance. By selecting the configuration button 317, the user will be shown the options to personalize the display of this performance, including the daily performance display options 601, weekly performance 603, monthly performance 605, annual performance 607, quarterly performance 609, and a period of time determined by the user 611. The daily performance option 601 shows the daily transaction in the display area 307, while the other options mentioned above show the graphs for the closing price data in the display area 307. The graph option 613 allows the user to configure the manner in which the performance data are displayed.

FIG. 7 illustrates the configuration options available and when the details button 313 is selected. After selecting this button the display area 307 will show information including the company's profits and losses related to the asset, the distribution of profits and losses per share, volume, maximum and minimum daily quotations, closing price on the last business day, the standard price and the quantity negotiated. By selecting the configuration option 317, the user is shown the options to personalize the display of these data, including the options to select a period for the data 701, displaying the maximum price 703, displaying the minimum price 705, displaying the free-floating price 707, displaying the corporate balance sheet 709, displaying the earnings per share 711 and displaying the US GAP data 713.

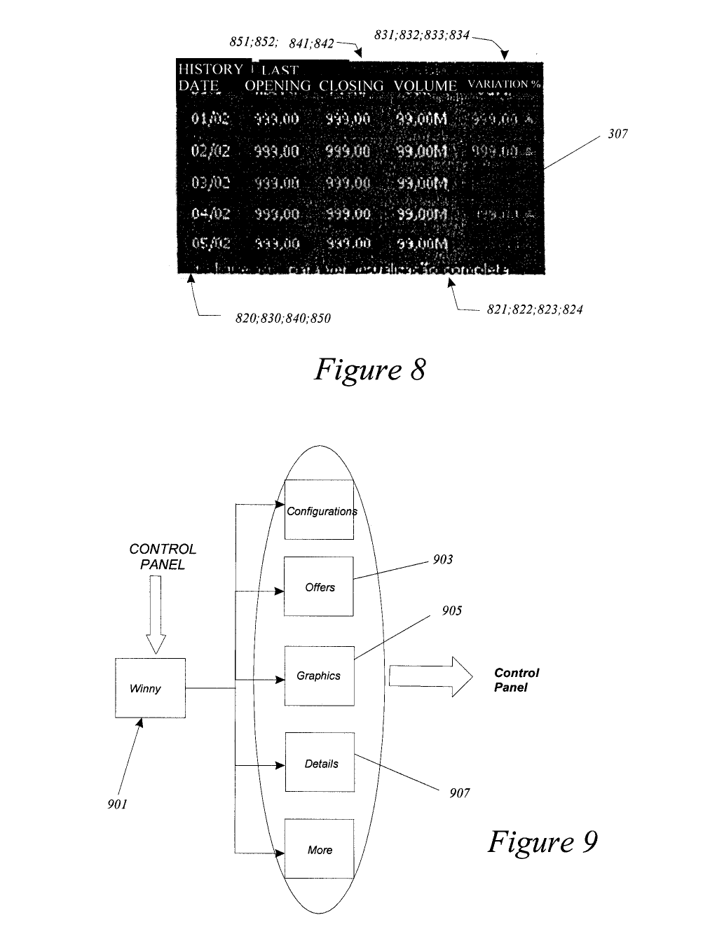

FIG. 8 illustrates the configuration options available when the “more” button 315 is selected. By selecting this button the display area 307 will show the button for the shares options list 820, a historical button 830, a latest news button 840, and a delete button 850. When selected, the shares options list 820 shows all of the shares options negotiated by the company and in relation to the asset of the company selected. A total options button 821 allows one to view all shares options. A call option button 822 allows one to view the share option calls, a sales option button 823 allows one to view the shares option sales and a term button 824 allows one to view the term of the shares options. The historical button 830 allows one to configure the asset's historical data. The daily button 831 displays all of the transactions on that day. A weekly button 832 displays the weekly closing price data. A monthly button 833 displays the monthly closing price data. An annual button 834 displays the annual closing price data. A period button 834 displays the closing price data for a period of time selected by the user. When selected, the latest news button 840 display the news related to the asset. The channel button 841 allows the user to select a specific news channel to obtain information. The general button 842 allows the user to select all of the information channels. When selected, the delete button 850 provides information about who is buying and who is selling the asset in the market, and the quantity being negotiated in sales. A net button 851 allows the display of consolidated information, while the analytical button 852 allows the display of specific information for specific buyers and/or sellers.

FIG. 9 illustrates a diagram describing the method for displaying asset information consistent with the present invention, the stages being carried out by a program in the memory. A terminal shows the market information display interface for a user (stage 901). When an offer button is selected, the configuration options to display the offer information are shown by selecting the configuration button (stage 903). When the graph button is selected, the configuration options are shown to display graphic information when selecting the configuration button (stage 905). When the details button is selected, the configuration options to display the asset's detailed information are shown when selecting the configuration button (stage 907).

Although the embodiments consistent with the present invention have been illustrated, it is understood by those familiar with the subject that various changes may be made and the equivalents may be substituted by their elements without removing the real scope of the invention. Consequently, this invention is not intended to limit any of the particular embodiments divulged, but the invention includes all of the embodiments shown within the scope of the claim present in this document.

1.- A method in a data processing system with a program to present a display of market information referring to an asset commercialized in a market, the method comprising the steps of:
display of a window including a market information display area;
display of an offer button, a graphs button and a details button in the window;
display of a configuration button in a window; and
market information variation shown in a display area when the configuration button is selected, provided that at least one of the offer button, graphic button and detail button is also selected.

2.- The method of claim 1, wherein the varied information includes configuration options for the window.

3.- The method of claim 2, wherein, when the offers button is selected, the configuration button provides options for at least one of the sale offers chosen for an asset at the same price, choosing the purchase offers for an asset at the same price, displaying at least one sale offer for an asset, displaying at least one purchase offer for an asset and change the color of the window.

4.- The method of claim 2, wherein when the graphics button is selected, selection of the configuration button provides option for graphically displaying market information.

5.- The method of claim 3 in which the options include a display of market information for an asset based on one of the daily periods, weekly periods, monthly periods, annual periods, quarterly periods and a user-defined period.

6.- The method of claim 2, wherein when the details button is selected, the selection of the configuration button provides options information for at least one of the maximum price information, minimum price information, profit information, loss information and earnings per share information.

7.- The method of claim 1, further comprising displaying a more tab and varying the information shown in the display area when the configuration button is selected and provided that one other button is also selected.

8.- The method of claim 7, wherein the information includes at least one of the share option information, historical information for an asset and information about the asset.

9.- The method of claim 8, wherein the share option information includes purchase and sale option information.

10.- The method of claim 8, wherein the asset news information includes news about the company related to the asset.

11.- A medium readable by computer that stores instructions executable by computer to execute a method of showing a market information display regarding an asset commercialized in a market; the method comprising the steps of:
display of a window including a market information display area;
display of an offer button, a graphics button and a details button in the window;
display of a configuration button in a window; and
market information variation shown in a display area when the configuration button is selected, provided that at least one of the offer button, graphics button and detail button is also selected.

12.- The method of claim 11, wherein the varied information includes configuration options for the window.

13.- The method of claim 12, wherein when the offer button is selected, the selection of the configuration button provides options for at least one of sorting sell offers for the asset for the same price, sorting buy offers for the asset for same price, displaying at least one sales offer for the asset, displaying at least one purchase offer for an asset and change the color of the display window.

14.- The method of claim 12, wherein when the graphics button is selected, the selection of the configuration button provides options to display market information graphics.

15.- The method of claim 13, characterized by the options that include the display of market information for an asset based on daily periods, weekly periods, monthly periods, annual periods and quarterly periods and a user-defined period.

16.- The method of claim 12, wherein when the details button (313) is selected, the selection of the configuration button offers options for at least one of the maximum price information, minimum price information, profit information, loss information and information on earnings per share.

17.- The method of claim 11, further comprising displaying a more tab and the variation of the information shown in the display area when the configuration button is selected and provided that another button is also selected.

18.- The method of claim 17, wherein the information includes at least one share option information, historical information for the asset and asset news information.

19.- The method of claim 18, wherein the shares option information includes purchase and sale options information.

20.- The method of claim 18, wherein asset news information includes news about the company related to the asset.

21.- A system to show a market information display regarding an asset commercialized in a market, comprising:
a memory including instructions to show a window with a market information display area, display of an offers button, graphics button and a details button in the window, display of a configuration button in the window, and market variation information shown in the display area when the configuration button is selected, provided that at least one of the offers buttons, graphics button and details button are also selected; and
a processor to execute the instructions.
